(19) United States
(12) Patent Application Publication
(10) Pub. No.: US 2014/0245333 A1
(43) Pub. Date: Aug. 28, 2014

(54) APPARATUS AND METHOD FOR FOCUSING A LASER BEAM ON AN OPTICAL DISC

(71) Applicant: Toshiba Samsung Storage Technology Korea Corporation, Suwon-si (KR)

(72) Inventors: Jin-ho JEONG, Seoul (KR); Eun-goo KIM, Suwon-si (KR)

(73) Assignee: Toshiba Samsung Storage Technology Korea Corporation, Suwon-si (KR)

(21) Appl. No.: 14/189,024

(22) Filed: Feb. 25, 2014

(30) Foreign Application Priority Data
Feb. 25, 2013 (KR) 10-2013-0020024

(51) Int. Cl. G11B 7/09; G11B 7/1376; G11B 7/1374

(52) U.S. Cl. CPC G11B 7/0927; G11B 7/1374; G11B 7/1376
USPC 720/659; 369/112.24

(57) ABSTRACT

Provided are a method and apparatus for focusing a laser beam on an optical disc. According to various aspects, the apparatus may include an objective lens which has a numerical aperture below what is standardized for the optical disc. In addition, a collimating lens which is used to focus a laser beam on the objective lens may be positioned at a fixed location. Despite the fixed location, the apparatus may support data recording/reproducing on multiple layers of the optical disc.

### CROSS-REFERENCE TO RELATED APPLICATION(S)

This application claims the benefit under 35 USC §119 (a) of Korean Patent Application No. 10-2013-0020024, filed on Feb. 25, 2013, in the Korean Intellectual Property Office, the entire disclosure of which is incorporated herein by reference for all purposes.

### BACKGROUND

1. Field

The following description relates to an optical pickup and a method for focusing a laser beam on a disc having a plurality of recording layers.

2. Description of Related Art

An optical pickup device may be designed to be used with multiple types of optical discs such as a compact disc (CD), a digital versatile disc (DVD), and a Blu-ray (BD) disc.

An optical system including the optical pickup device for multi-media typically includes an objective lens for a CD/DVD and another objective lens for a BD, as well as a beam splitter, a collimating lens, and a mirror. In the conventional art, an optical system corresponding to CD/DVD and an optical system corresponding to BD require different optical distances from each other. Therefore, the different optical distances required by the optical systems have to be ensured when combining the optical systems for CD/DVD and BD into one structure.

A conventional optical pickup device corresponding to multi-optical discs typically has a structure in which an independent optical system corresponding to CD/DVD and an independent optical system corresponding to BD are simply combined into one structure.

In the conventional optical pickup device, a region is shared by the optical system for CD/DVD and the optical system for BD, that is, a beam path from a beam splitter to an objective lens which is shared by a beam for CD/DVD and a beam for BD. A collimating system is located on the beam path, and is used to adjust optical distances for each of optical discs and each of recording layers of the optical disc. The collimating system typically includes a conveying system including the collimating lens through which the beam is transmitted, and a stepping motor which is used to adjust a location of the collimating lens. In this type system, the conveying system must adjust the distance between the collimating lens and the object lens to properly write data and read data to and from multiple layers of an optical disc.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect, there is provided a A method of focusing a laser beam, the method including generating a laser beam toward a multi-layered optical disc comprising a first layer and a second layer on which information is recorded, transmitting the laser beam through a collimating lens that is fixed at an intermediate location between optimal reproducing locations of the first layer and the second layer of the optical disc, and focusing the laser beam passing through the collimating lens onto the multi-layered optical disc using an objective lens comprising a numeric aperture (NA) that is less than a standardized NA for the multi-layered optical disc.

The standardized NA may be 0.85 and the NA of the objective lens may comprise a range from among 0.70 to 0.80.

The standardized NA may be 0.85 and the NA of the objective lens may comprise 0.75.

The multi-layered optical disc may comprise a Blu-ray disc (BD).

In an aspect, there is provided an optical pickup device including a light source configured to generate a laser beam comprising a wavelength corresponding to a multi-layered optical disc including a first layer and a second layer on which information is recorded, an objective lens configured to focus the laser beam on the multi-layered optical disc, and comprising a numeric aperture (NA) that is less than a standardized NA for the multi-layered optical disc, and a collimating lens disposed on an optical path between the light source and the objective lens, and being fixed at a location of the optical path between optimal reproducing locations of the first layer and the second layer of the optical disc.

The optical pickup device may further comprise a second objective lens corresponding to a second optical disc that is different from the multi-layered optical disc, and a second light source corresponding to the second objective lens.

The multi-layered optical disc may comprise a Blu-ray disc (BD), and the second optical disc may comprise at least one of a digital versatile disc (DVD) and a compact disc (CD).

In an aspect, there is provided an optical disc drive including an optical system including an optical pickup device comprising an objective lens for focusing a laser beam on a multi-layered optical disc, and having a numeric aperture (NA) that is less than 0.85, and a collimating lens disposed on an optical path between a light source and the objective lens and fixed at a location of the optical path that is between optimal reproducing locations of a first layer and a second layer of the multi-layered optical disc, a mechanical system mechanically supporting the optical system, and a circuit unit processing signals from the optical pickup device and controlling the mechanical system.

The optical disc drive may further comprise a light source generating a laser beam for a CD and a laser beam for DVD corresponding to the CD and DVD

Other features and aspects will be apparent from the following detailed description, the drawings, and the claims.

### BRIEF DESCRIPTION OF THE DRAWINGS

FIG. 1 is a diagram illustrating an example of an optical pickup device.

FIG. 2 is a diagram illustrating an example of a location of a collimating lens in the optical pickup device of FIG. 1.

FIG. 3 is a diagram illustrating an example of a collimating lens conveying system used in a conventional optical pickup device.

FIGS. 4A and 4B are graphs illustrating an example of variations in tracking error levels according to locations of a collimating lens, in a case of different numeric apertures of an objective lens.

FIGS. 5A and 5B are graphs illustrating an example of variations in jitter characteristics according to locations of the collimating lens, in a case of different numeric apertures of the objective lens.

FIG. 6 is a diagram illustrating an example of an optical disc drive including an optical pickup device.

FIG. 7 is a diagram illustrating another example of an optical pickup device.

FIG. 8 is a diagram illustrating an example of a method for focusing a laser beam on an optical disc which includes multiple layers

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses and/or systems described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

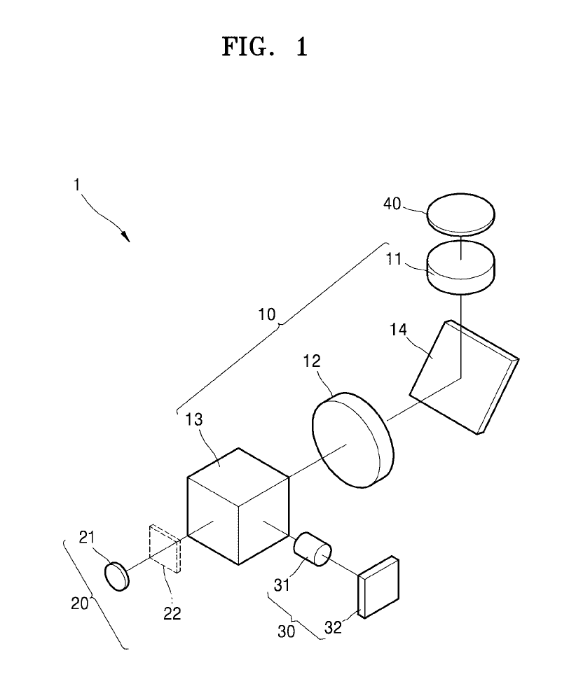

FIG. 1 illustrates an example of an optical pickup device 1. In particular, FIG. 1 illustrates an example of an optical pickup device for a Blu-ray disc (BD) which uses an optical disc that has a multi-layered structure.

Referring to FIG. 1, optical pickup device 1 includes an optical disc 40 that has a plurality of recording layers, a transmission system 10 corresponding to a dual layer Blu-ray disc (DL BD), and a light source system 20 including a light source 21 for BD providing a single beam for reproducing and/or recording information from/to the optical disc 40. In this example, the optical pickup device 1 also includes a light receiving system 30 that has a light receiving device 32 for receiving a beam reflected from the optical disc 40 and for generating electric signals for processing a data signal and a tracking error signal (TES) in order to reproduce information.

The light source system 20 includes the light source 21 for BD that may generate a laser beam for BD, and a grating element 22 that is used to diffract the laser beam into three-beams in a case of a three-beam type optical pickup device. In the alternative, the grating element 22 may not be included in a one-beam type optical pickup device.

The light receiving system 30 includes the light receiving device 32 for detecting a laser beam which is reflected by the optical disc 40 and which passes through the beam splitter 13, and a sensing lens 31 for focusing the laser beam to a size appropriate for the light receiving device 32.

The transmission system 10 includes an objective lens 11 corresponding to the optical disc 40, a mirror 14 for changing an optical path, a collimating lens 12, and a beam splitter 13. As merely an example, the beam splitter 13 may be configured to allow the beam from the light source system 20 to pass through and proceed toward the objective lens 11, and direct a beam reflected by the optical disc 40 toward the light receiving system 30, or vice versa.

Typically, a generalized or standardized numeric aperture that is required for a BD lens is a numerical aperture of 0.85. However, a numerical aperture that is different from 0.85 may be applied to the objective lens 11. For example, the objective lens 11 according to various aspects, in particular, the objective lens 11 for a Blu-ray disc that has the plurality of recording layers may have a numeric aperture of less than 0.85. For example, the numerical aperture of the objective lens 11 for a Blu-ray disc as described herein may be reduced to a range of 0.70 to 0.80.

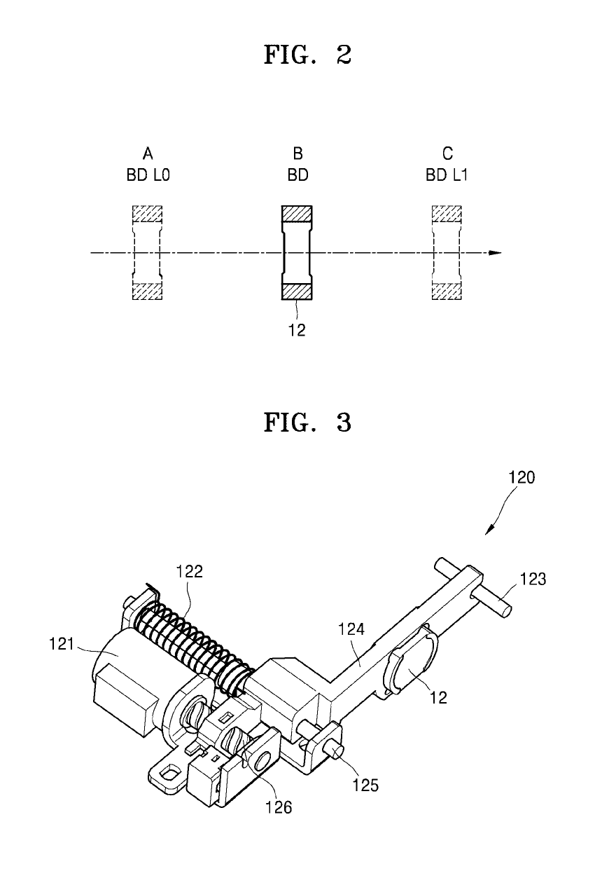

Furthermore, in a conventional art, a conveying system is required to move a collimating lens 12 closer to and farther away from the objective lens in order to successfully record and reproduce data from and to a multi-layer disc such as a BD. An example of a conveying system 120 in the conventional art is illustrated in FIG. 3. That is, in the conventional art an additional conveying system 120 is necessary to record to the multi-recording layers, for example, layers L0 and L1 of the optical disc as shown in FIG. 2. Here, L0 denotes an optical recording/reproducing location of the collimating lens for a lowermost recording layer in a BD and L1 denotes an optical recording/reproducing location of the collimating lens for an upper recording layer in a BD having the multi-layered structure. As another example, the optical disc may have a three-layered (L0, L1, and L2) or a four-layered (L0, L1, L2, and L3) structure, and the collimating lens may need to be moved to locations corresponding to L2 or L3, in addition to L0 and L1.

An example of the conveying system 120 used in the conventional optical pickup device is described with reference to FIG. 3. In the conveying system 120, the collimating lens 12 is coupled to a conveying unit 124 of a frame, and the conveying unit 124 is engaged with a lead screw 126 of an actuator 121. Therefore, the conveying unit 124 moves along an axial direction of the lead screw 126 when the lead screw 126 of the actuator 121 rotates. Guide shafts 123 and 125 for guiding the conveyance of the conveying unit 124 are disposed at opposite sides of the conveying unit 124, and a buffer spring 122 for elastically pressing the conveying unit 124 in a direction is disposed on the guide shaft 125.

According to various aspects, however, the collimating lens 12 described herein may be set at a fixed location regardless of layer. For example, referring to FIG. 2, a location of the collimating lens 12 may be fixed at an intermediate location B between optimal recording/reproducing locations A and C of the collimating lens 12, which correspond to optimal recording and reproducing locations for the layers L0 and L1 (or L2 or L3) in the optical pickup device. By fixing the collimating lens 12 at the intermediate location, the conveying system 120, which is highly expensive, is not necessary because a location of the collimating lens may be fixed at a time of manufacture.

According to various aspects, the optical pickup device may use a objective lens having a numerical aperture below a typical 0.85, and may not need the above described conveying system 120. Accordingly, a plurality of components of high prices requiring complicated assembling processes are not used thus reducing the overall cost of production and assembly and improving the efficiency of the optical pickup device.

Moreover, there is no problem in recording or reproducing information from/to the optical disc having the plurality of recording layers such as a BD even with a reduced numerical aperture in the objective lens. According to example experiments, when the numeric aperture of the objective lens 11 for BD was reduced to 0.85 or lower in a state in which the location of the collimating lens 12 is fixed, there was no problem in tracking, focusing, and recording/reproducing of information to and from the optical pickup device.

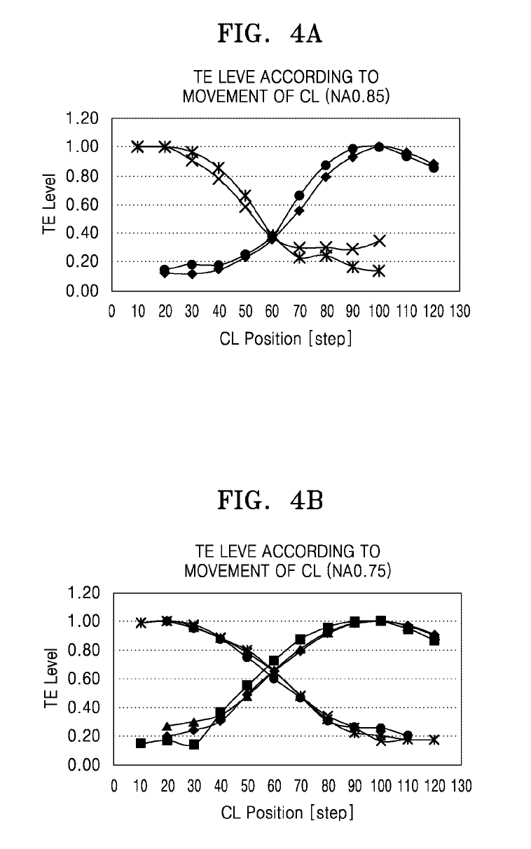

FIGS. 4A and 4B are graphs illustrating examples of experimental results of tracking error levels according to a method of focusing a laser beam.

The graphs of FIGS. 4A and 4B show variations in a tracking error (TE) level according to locations of the collimating lens 11 in an example in which the numeric aperture of the objective lens 11 is 0.85 (FIG. 4A) and in an example in which the numeric aperture of the objective lens 11 is 0.75 (FIG. 4B).

When comparing the graphs of FIGS. 4A and 4B, a difference between the TE levels is not large at locations corresponding to the layers L0 and L1, that is, left and right regions in the graphs. However, at an intermediate location such as at the step 60, the graph of FIG. 4B shows a far better result in comparison to the graph of FIG. 4A. That is, when the objective lens having the numeric aperture of 0.85 was used, a very defective (low) TE level was shown at a location B (refer to FIG. 2), that is, an intermediate location between locations A and C corresponding to the layers L0 and L1. In contrast, when the objective lens having the numeric aperture of 0.75 was used, the TE level of higher quality was shown at the intermediate location. That is, when the collimating lens 11 is apart from the optimal locations A and C for the recording layers, a magnitude of the TE signal is reduced, and thus, it is difficult to control the optical disc drive. However, when the numeric aperture of the objective lens is reduced, the reduction in the TE signal is improved as shown in FIG. 4B.

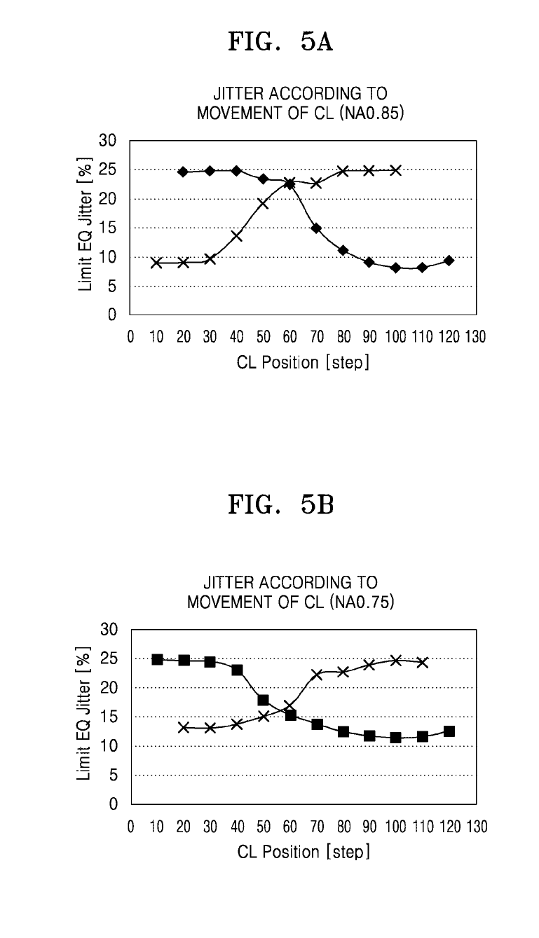

Similar to the above TE level experiment results, a test for comparing jitter characteristics as show in FIGS. 5A and 5B, shows similar results to those of FIGS. 4A and 4B. In this example, when the objective lens having the numeric aperture of 0.85 was used, a very high (defective) jitter characteristic was shown at location B. In contrast, when the objective lens having the numeric aperture of 0.75 was used, the jitter characteristic at the location B is slightly higher than the opposite sides of the graph, but does not cause a problem in a practical use in comparison to the numerical aperture of 0.85.

That is, if the collimating lens is located at an optimal location with respect to each of the recording layers, the jitter characteristic is optimal in a case where the objective lens has the numeric aperture of 0.85. However, such a system requires a conventional conveying system to move the collimating lens.

However, when the numeric aperture is reduced, the variation according to the movement of the collimating lens is reduced. Therefore, when the collimating lens is disposed at an intermediate location and not moved between the optimal locations, the jitter characteristic is better when the objective lens has the numeric aperture of 0.75 instead of when the objective lens has the numeric aperture of 0.85, at the intermediate location between the recording layers L0 and L1. According to various aspects, the optical pickup device corresponding to BD may be implemented while satisfying the TE signal and the reproducing characteristics of the optical disc drive, in a state in which the location of the collimating lens is fixed.

According to the experiments, when the collimating lens is fixed at the intermediate location B as shown in the example of FIG. 2, the appropriate numeric aperture of the objective lens may range from 0.70 to 0.80, for example, 0.75.

In the above description, the BD is exemplary recited as the optical disc that needs to move the collimating lens. However, the embodiments of the present invention are not limited thereto and may be applied to any kind of optical system for the optical disc having the plurality of layers, wherein the optical system needs to move the collimating lens.

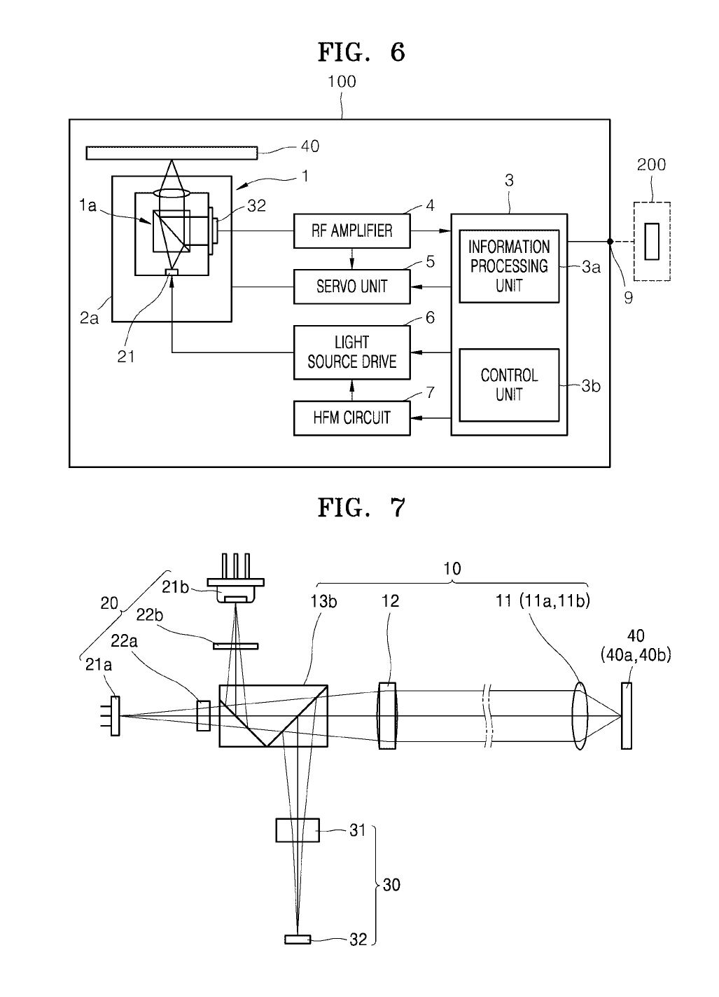

FIG. 6 illustrates an example of an optical disc drive including an optical pickup device.

Referring to FIG. 6, optical disc drive 100 includes the optical pickup device for reading and/or recording information from/to an optical disc 40, for example, the optical pickup device 1 as shown in FIG. 1. The optical pickup device 1 may include the optical system that is described above, and additionally include a mechanical system 2a mechanically supporting the optical system and triggering a focusing operation and a tracking operation of the objective lens. The light receiving device 32 may be electrically connected to a front-end part (IC) 4 including a radio frequency (RF) amplifier, and the light source 21 may be connected to a light source driver (or a laser diode driver (LDD)) 6. The light source driver 6 may be connected to a high frequency modulation (HFM) circuit 7 for removing an HFM component.

The mechanical system 2a of the optical pickup device 1 is connected to a servo unit 5. The servo unit 5 may be used to control the tracking and focusing operations of the optical pickup device 1, but may not control the location of the collimating lens that is conventionally performed in the optical disc drive, according to various aspects herein because the location of the collimating lens may be fixed. In this example, the front-end part 4, the servo unit 5, the light source driver 6, and the HFM circuit 7 are connected to a digital signal processor (DSP) 3. The DSP 3 includes an information processing unit including a decoder and an encoder for processing signals from the front-end part 4, and a system control unit 3b for controlling all the components in the system such as the servo unit 5, the light source driver 6, and the HFM circuit 7.

The optical pickup device, for example, the optical pickup device shown in FIG. 1 has a structure that is exclusive for the BD; however, it should be appreciated that the method of focusing the laser beam according to various aspects may be applied to an optical pickup device corresponding to multi-media, that is, corresponding to CD/DVD in addition to the BD.

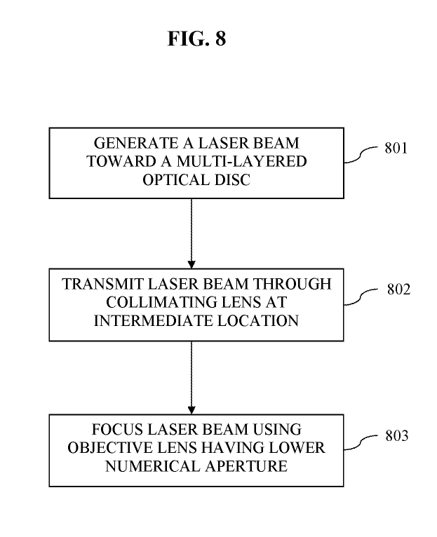

FIG. 7 illustrates another example of an optical pickup device 1 corresponding to multi-media.

Referring to FIG. 7, the optical pickup device 1 includes a transmission system 10 corresponding to multiple types of media 1 such as CD/DVD and BD, a light source system 20 providing a light beam for reproducing and/or recording information from/to the optical disc 40, and a light receiving system 30 for receiving a light beam reflected from the optical disc 40 to generate an electric signal in order to reproduce the information.

For example, the light source system 20 includes a first light source 21a for CD/DVD and a second light source 21b for BD. A grating element 22a for CD/DVD and a grating element 22b for BD are disposed in front of the first light source 21a and the second light source 21b, respectively. The two grating elements 22a and 22b may be used to diffract the laser beams from the light sources 21a and 21b to respectively form a main beam and ±1st order sub-beams. As such, the laser beam including the main beam and the sub-beams may be directed towards the transmission system 10.

The transmission system 10 includes a beam splitter 13b which determines a proceeding direction of the laser beam, a collimating lens which may be used for compensating for a spherical aberration based on a type of the optical disc 40 and a change in an access layer of the optical disc, and an objective lens 11 focusing the laser beam from the light source system 20 on the optical disc 40. For example, the collimating lens 13b may correct an aberration of the laser beam spot formed on the optical disc 40 by adjusting a beam flux in a state of being fixed on a location.

The light receiving system 30 includes the light receiving device 32 for receiving the laser beam incident through the beam splitter 13b from the optical disc 40, and the sensing lens 31 for concentrating the laser beam to the light receiving device 32 to be an appropriate size.

In FIG. 7, the optical disc 40 is representatively shown, and may include a CD/DVD 40a and a BD 40b. The beam splitter 13b in the transmission system 10 may cause the laser beam from the light source system 20 to proceed toward the objective lens 11, and cause the beam reflected from the optical disc 40 to proceed toward the light receiving system 30. The objective lens 11 may include an objective lens 11a for CD/DVD and an objective lens 11b for BD.

In the above structure, the objective lens 11b for BD has the numeral aperture that is less than 0.85 that is generally used as a standard, for example, the objective lens may have a numeric aperture of 0.75. In addition, the collimating lens may be fixed at a located B. Therefore, according to various aspects, the location adjustment of the collimating lens for CD/DVD, as well as the collimating lens for BD, is not necessary. Here, the CD and DVD may be less sensitive to the variation in the location of the collimating lens, than the BD; however, may be optimized with respect to the collimating lens, the location of which is fixed at a point by adjusting the optical distances appropriately.

FIG. 8 illustrates an example of a method for focusing a laser beam on an optical disc which includes multiple layers.

Referring to FIG. 8, the method includes generating a laser beam toward a multi-layered optical disc comprising a first layer and a second layer on which information is recorded, in 801.

The method further includes transmitting the laser beam through a collimating lens that is fixed at an intermediate location between optimal reproducing locations of the first layer and the second layer of the optical disc, in 802. For example, the collimating lens may be fixed at location corresponding to B, between locations A and C as shown in FIG. 2.

The method further includes, focusing the laser beam passing through the collimating lens onto the multi-layered optical disc using an objective lens comprising a numeric aperture (NA) that is less than a standardized NA for the multi-layered optical disc, in 803. For example, the NA of the objective lens may have a value of less than the standardized value of 0.85, such as 0.70 or 0.80.

According to various aspects, laser beams may be generated toward an optical disc having a first layer and a second layer, on which information is recorded, and the laser beams may be focused on the first layer or the second layer of the optical disc by using an objective lens having a numeric aperture that is less than a standardized numeric aperture of the optical disc (0.85). Here, the laser beam may pass through a collimating lens that is fixed at the location between the two locations A and C corresponding to the first and second layers of the optical disc before passing through the objective lens. As a result, a conventional conveying system is not needed to move the collimating lens between optimal locations for recording on multiple layers of a disc.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of focusing a laser beam, the method comprising:
generating a laser beam toward a multi-layered optical disc comprising a first layer and a second layer on which information is recorded;
transmitting the laser beam through a collimating lens that is fixed at an intermediate location between optimal reproducing locations of the first layer and the second layer of the optical disc; and
focusing the laser beam passing through the collimating lens onto the multi-layered optical disc using an objective lens comprising a numeric aperture (NA) that is less than a standardized NA for the multi-layered optical disc.

2. The method of claim 1, wherein the standardized NA is 0.85 and the NA of the objective lens comprises a range from among 0.70 to 0.80.

3. The method of claim 2, wherein the standardized NA is 0.85 and the NA of the objective lens comprises 0.75.

4. The method of claim 1, wherein the multi-layered optical disc comprises a Blu-ray disc (BD).

5. An optical pickup device comprising:
a light source configured to generate a laser beam comprising a wavelength corresponding to a multi-layered optical disc including a first layer and a second layer on which information is recorded;
an objective lens configured to focus the laser beam on the multi-layered optical disc, and comprising a numeric aperture (NA) that is less than a standardized NA for the multi-layered optical disc; and
a collimating lens disposed on an optical path between the light source and the objective lens, and being fixed at a location of the optical path between optimal reproducing locations of the first layer and the second layer of the optical disc.

6. The optical pickup device of claim 5, further comprising a second objective lens corresponding to a second optical disc that is different from the multi-layered optical disc, and a second light source corresponding to the second objective lens.

7. The optical pickup device of claim 6, wherein the multi-layered optical disc comprises a Blu-ray disc (BD), and the second optical disc comprises at least one of a digital versatile disc (DVD) and a compact disc (CD).

8. The optical pickup device of claim 5, wherein the standardized NA is 0.85 and the NA of the objective lens comprises a range from among 0.70 to 0.80.

9. The optical pickup device of claim 8, wherein the standardized NA is 0.85 and the NA of the objective lens comprises 0.75.

10. An optical disc drive comprising:
an optical system including an optical pickup device comprising:
an objective lens for focusing a laser beam on a multi-layered optical disc, and having a numeric aperture (NA) that is less than 0.85, and
a collimating lens disposed on an optical path between a light source and the objective lens, and fixed at a location of the optical path that is between optimal reproducing locations of a first layer and a second layer of the multi-layered optical disc;
a mechanical system mechanically supporting the optical system; and
a circuit unit processing signals from the optical pickup device and controlling the mechanical system.

11. The optical disc drive of claim 10, further comprising a second objective lens corresponding to a second optical disc that is different from the multi-layered optical disc, and a second light source corresponding to the second objective lens.

12. The optical disc drive of claim 10, wherein the multi-layered optical disc comprises a Blu-ray disc (BD), and the second optical disc comprises at least one of a digital versatile disc (DVD) and a compact disc (CD).

13. The optical disc drive of claim 12, wherein the NA of the objective lens comprises a range from among 0.70 to 0.80.

14. The optical disc drive of claim 10, wherein the NA of the objective lens comprises 0.75.

15. The optical disc drive of claim 12, further comprising a light source generating a laser beam for a CD and a laser beam for DVD corresponding to the CD and DVD.
